(19) United States
(12) Patent Application Publication
(10) Pub. No.: US 2013/0116991 A1
(43) Pub. Date: May 9, 2013

(54) TIME SERIES DATA ANALYSIS METHOD, SYSTEM AND COMPUTER PROGRAM

(71) Applicant: International Business Machines Corporation, Armonk, NY (US)

(72) Inventor: Shohei Hido, Kanagawa-ken (JP)

(73) Assignee: INTERNATIONAL BUSINESS MACHINES CORPORATION, Armonk, NY (US)

(21) Appl. No.: 13/667,672

(22) Filed: Nov. 2, 2012

(30) Foreign Application Priority Data
Nov. 8, 2011 (JP) 2011-244834

(51) Int. Cl. G06F 17/10

(52) U.S. Cl. 703/2

(57) ABSTRACT

A method includes selecting, with a computer, a time lag that is the time delay until an explanatory variable time sequence applies an effect on a target variable time series, and a time window that is the time period for the explanatory variable time series to apply the impact on the target variable time series; converting, based upon the explanatory variable time series, to a cumulative time series structured by the cumulative values of each variable from each time point corresponding to a certain finite time; and solving the cumulative time series as an optimized problem introducing a regularization term, to obtain the value of the time lag and the value of the time window from the solved weight.

### PRIORITY

This application claims priority to Japanese Patent Application No. 2011-244834, filed Nov. 8, 2011, and all the benefits accruing therefrom under 35 U.S.C. §119, the contents of which in its entirety are herein incorporated by reference.

### BACKGROUND

The present invention relates to analytical technology for time series data, and more particularly to selecting an optimal time lag and time window for each variable in a time series prediction problem.

Generally, a multidimensional time series prediction problem (including recovery problems and class identification problems) are problems that predict the value of the next time series in a target variable time series from D types of explanatory variables in a time series. As specific examples, there can be offered those which predict a stock price from various economic indices, those which predict climate change and weather from various meteorological data, and those which predict the failure of mechanical systems from various sensor data. When solving such a multidimensional time series prediction problem, it is necessary to set an optimal time lag and time window for each explanatory variable in the time series. On this point, time lag L refers to the time delay until a certain original explanatory variable has an impact on a target variable. In addition, time window W refers to the length of the period in which a certain original explanatory variable has an impact on a target variable. In an actual target system there exists a complex causality between an explanatory variable and a target variable. Specifically, and there exists an impact size, time delay (time lag), and impact width (time window) that differs according to the explanatory variable. For example, for the Japan Nikkei Average, the New York Dow has an immediate (short time lag) and sharp (short time window) impact, but a drop in domestic consumer sentiment has a delayed (long time lag) and protracted (long time window) impact.

With such a time series prediction problem, statistical approaches have conventionally been tested. In the field of statistics, there is a long history of research with AR (autoregressive) models in one-dimensional situations, and research on VAR (vector autoregressive) in multidimensional situations. However, in multidimensional situations, the method of examining the length of the model is central, and when exceeding several dimensions, there is a problem in that the reliability of the method greatly declines. Mechanical learning approaches have also been tested. In the field of mechanical learning, the main current is a sliding window method for considering the time lag and time window. In many situations, all of the explanatory variables are handled by identical time lag and time windows. The results are unsuitable in situations where there exist explanatory variables that apply a diversity of impacts (when the time lag and time window differ for each explanatory variable). In addition, one of either the or window is adjusted to reduce calculation volume, and this complicates discovery of an optimal combination. The following patent literature can be offered as literature on the subject.

### SUMMARY

In one embodiment, a method includes selecting, with a computer, a time lag that is the time delay until an explanatory variable time sequence applies an effect on a target variable time series, and a time window that is the time period for the explanatory variable time series to apply the impact on the target variable time series; converting, based upon the explanatory variable time series, to a cumulative time series structured by the cumulative values of each variable from each time point corresponding to a certain finite time; and solving the cumulative time series as an optimized problem introducing a regularization term, to obtain the value of the time lag and the value of the time window from the solved weight.

In another embodiment, a computer program product includes a computer readable storage medium having computer readable code stored thereon that, when executed by a computer, implement a method. The method includes selecting, with the computer, a time lag that is the time delay until an explanatory variable time sequence applies an effect on a target variable time series, and a time window that is the time period for the explanatory variable time series to apply the impact on the target variable time series; converting, based upon the explanatory variable time series, to a cumulative time series structured by the cumulative values of each variable from each time point corresponding to a certain finite time; and solving the cumulative time series as an optimized problem introducing a regularization term, to obtain the value of the time lag and the value of the time window from the solved weight.

In another embodiment a system includes a computer configured to select a time lag that is the time delay until an explanatory variable time sequence applies an effect on a target variable time series, and a time window that is the time period for the explanatory variable time series to apply the impact on the target variable time series. The computer is configured to convert, based upon the explanatory variable time series, to a cumulative time series structured by the cumulative values of each variable from each time point corresponding to a certain finite time; and solve the cumulative time series as an optimized problem introducing a regularization term, to obtain the value of the time lag and the value of the time window from the solved weight.

### BRIEF DESCRIPTION OF THE SEVERAL VIEWS OF THE DRAWINGS

FIG. 1 is a block diagram of an exemplary computer suitable for practicing teachings of the present embodiments.

FIG. 2 is a flow chart that shows the operation of the computer of FIG. 1, in accordance with an exemplary embodiment.

FIG. 3 is a pattern drawing illustrating the original explanatory variable time series and the cumulative value sequence.

FIG. 4 is a chart that compares the coefficient of a true model with the coefficient of the proposed method model.

FIG. 5 is a chart that compares the coefficient of the proposed method model with the coefficient of an existing method model.

FIG. 6 is a chart that compares the coefficient of the proposed method model with the coefficient of an existing method model.

FIG. 7 is a chart that explains prediction error and model construction time with the proposed method and an existing method.

### DETAILED DESCRIPTION

The statistical approach and the mechanical learning approach have been problematic for reliable and efficient handling of multidimensional time series prediction problems. Accordingly, the present invention embodiments provide a time series data analysis method, system and computer program that is capable of structuring a more accurate prediction model by reliably and efficiently seeking a time lag and time window that differs for each explanatory variable within a multidimensional time series prediction problem. Specifically, the invention embodiments include a method that selects a time lag that is a time delay until an explanatory variable time series applies an impact on a target variable time series, and selects a time window that is the time period during which the described explanatory variable time series applies an impact on the target variable time series, and provides changing, based on the explanatory variable time series, to a cumulative value time series to be structured by the cumulative values of the variables from each time point corresponding to a finite time, and solving the cumulative time series as an optimized problem that has introduced a regularization term, and to obtain the value of the time lag and the value of the time window from the obtained weight.

Advantageously, the embodiments provide an ability to reliably and efficiently seek a time lag and time window that differs by each explanatory variable in a multidimensional time series prediction problem.

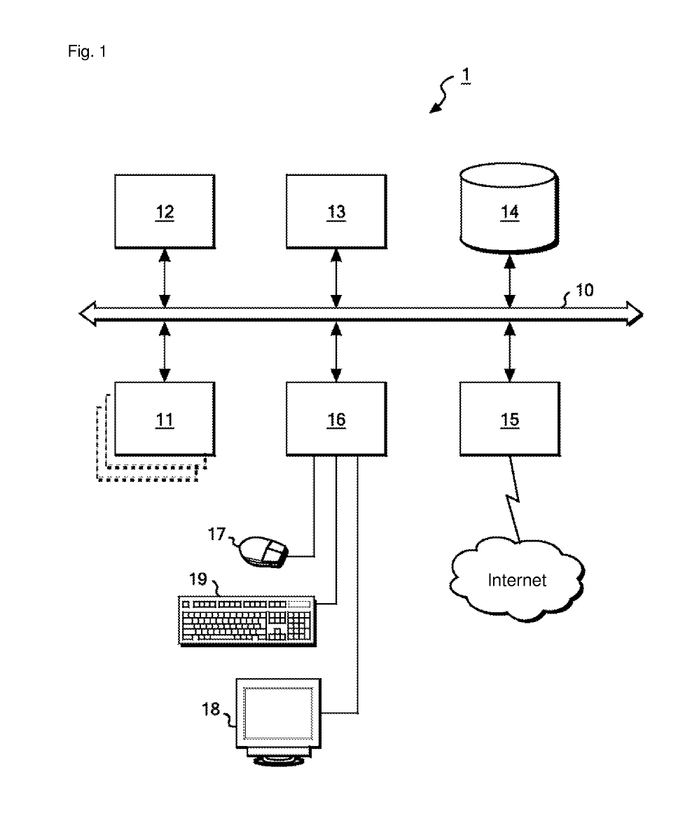

FIG. 1 is a function block diagram that shows the hardware configuration of a computer 1 according to this implementation mode. The hardware structure of computer 1 provides bus 10 (slow speed and high-speed), CPU (central processing unit) 11 connected to bus 10, RAM (random access memory, a memory device) 12, ROM (read only memory, a memory device) 13, HDD (hard disk drive, a memory device) 14, communications interface 15, and input-output interface 16. Furthermore, to input-output interface 16 there is connected mouse (pointing device) 17, flat panel display (display device) 18, and keyboard 19. Moreover, computer 1 is explained as equipment that has adopted a common personal computer architecture, but, for example, there can be executed multiplexing of CPU 11 and HDD 14 in order to implement higher data processing capacity and availability. There can also be adopted any of various types of computer systems, such as personal computers of a laptop or tablet type, in addition to those of a desktop type.

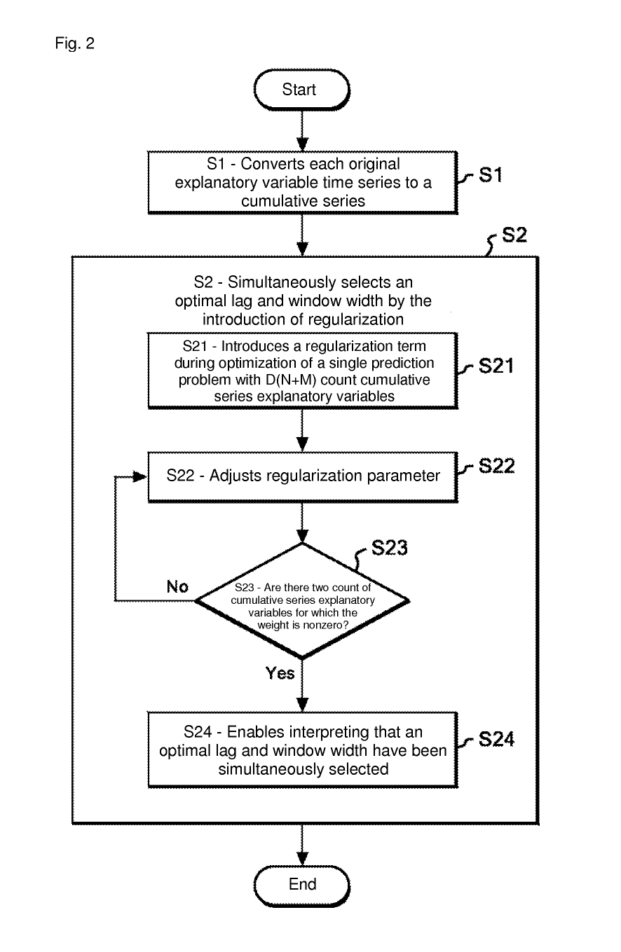

The software configuration within computer 1 provides an operating system (OS) to provide basic functions, application software that utilizes the functions of the OS, and driver software for the input-output devices. Each of these software applications is loaded into RAM 12 along with each type of data, and is executed by CPU 11, and computer 1 executes the processing shown in FIG. 2 as a complete unit.

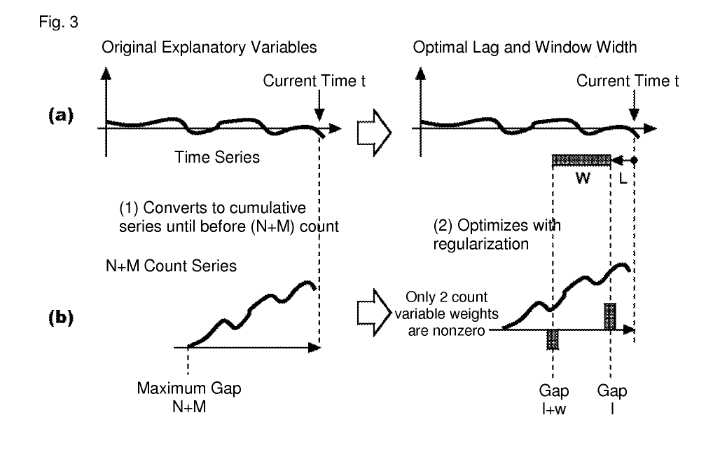

FIG. 2 is a flow chart that explains the processing executed by computer 1. This processing is structured by broad division into two steps (S1, S2). Moreover, FIG. 3 is a chart that representatively shows the stages of this processing.

There is simultaneously selected an optimal lag and window by the introduction of regularization (S2). First, a prediction problem constituted of D(N+M) count cumulative value series explanatory variables and a single target function is returned to an optimization problem for the target function, and regularization term is introduced to the within the target function (S21). At this point, the result is making the weight of the explanatory variable in the regularization term approach zero (spacing) and stabilizing of model construction. With this implementation mode, there is introduced an L1 regularization term with large effect for making zero the weight of unneeded variables. Specifically, when x_i is made the explanatory variable vector, y_i is made the value of the target variable, and beta is made the model, the output of the model is f(x_i, beta), and the seeking of beta, for minimizing the following target functions, results in a return to the optimization model. This signifies the seeking of a model to minimize prediction error.

Sigma(y_i−f(x_i,beta))̂2

Then, by introducing a regularization term (the L1 regularization term, for example) in order to prevent complication of the model (in this case, increasing the nonzero component), there results the following target function. Furthermore, |beta| is the sum of the absolute values of each element of beta.

Sigma(y_i−f(x_i,beta))̂2+lambda |beta|

Subsequently, the complexity of the model to be obtained is regulated by regulating the regularization parameter (S22). At this point, it is expected that only the weights of the several count cumulative value series explanatory variables for the original explanatory variables required for prediction will become nonzero, and, comparatively, it is expected that all weights the original explanatory variables not needed for prediction will become zero.

Specifically, in the above equation, lambda is the regularization parameter, and by adjusting the size of the value (lambda>=0), there is ability to minimize the total of the prediction error combined with lambda*(the sum of nonzero elements of beta). It is generally known that, when lambda becomes greater, the prediction error rises while the sum of the nonzero elements of beta becomes smaller (reducing also the quantity and size of the nonzero elements).

Then, the complexity of the model is adjusted until the cumulative value series explanatory variables for which the weight is nonzero becomes two count (S23), and, by having made the cumulative value series explanatory variables for which the weight is nonzero into two count, there is ability to interpret this as simultaneously selecting an optimal L and W (S24). Furthermore, for convenience at this point, there is put forward the assumption that an optimal time window and time lag exists for all the explanatory variables, and that these can be expressed by the weights of two or more nonzero cumulative series explanatory variables. On the other hand, it is also assumed that there exist, in the time window and time lag of an actual model, noise variables that do not hold significance for prediction, and weights of these are all made 0. In this case, it is evident that at S23 of FIG. 2 there is inclusion of natural expansion by arranging to “not change the cumulative series explanatory variables with weight nonzero from two count, nor change from zero count even when adjusting the regularization parameter.”

There is simultaneously selected an optimal lag and window by the introduction of regularization (S2). First, a prediction problem constituted of D(N+M) count cumulative value series explanatory variables and a single target function is returned to an optimization problem for the target function, and regularization term is introduced to the within the target function (S21). At this point, the result is making the weight of the explanatory variable in the regularization term approach zero (spacing) and stabilizing of the model structure. With this implementation mode, there is introduced an L1 regularization term with large effect for making zero the weight of unneeded variables. Subsequently, the complexity of the model to be obtained is regulated by regulating the regularization parameter (S22). At this point, it is expected that only the weights of the several count cumulative value series explanatory variables for the original explanatory variables required for prediction will become nonzero, and, comparatively, it is expected that all weights the original explanatory variables not needed for prediction will become zero.

Furthermore, the complexity of the model is adjusted until the cumulative value series explanatory variables for which the weight is nonzero becomes two count (S23), and, by having made the cumulative value series explanatory variables for which the weight is nonzero into two count, there is ability to interpret this as simultaneously selecting an optimal L and W (S24).

Specifically, when there have been obtained cumulative series explanatory variables c_t̂g1 and c_t̂g2 (g1<g2) for which the weight is nonzero, there is optimal L=g1 and W=g1−g2 (refer to FIG. 3(a) (b) left side. For example, the weight of c_t̂5 (gap g=5) is 1.0, and the weight of c_t̂15 (gap g=15) is −1.0, resulting in N+M=20. By weighting and summing these cumulative series, there is obtained the following value c′_t.

c′_{—}t={x_(t−5)+x_(t−6) + . . . x_(t−20)}−{x_(t−15)+x_(t−16)+ . . . x_(t−20)}

={x_(t−5)+x_(t−6)+ . . . +x_(t−14)}

This is equivalent to when lag L=5 and a window width W=10, and this enables interpreting that this combination is selected as the optimal set of values.

The following advantages can be offered by solving a multidimensional time series problem in this way. Specifically, in comparison to when simply combining both sides of differing time lags and differing time windows and preparing N*M types of conversion series for each explanatory variable (D*M*N variables), the calculation is made efficient and the model to be sought is made stable by the conversion series being completed with D(N+M) types. In addition, the expressive power becomes greater in comparison to when all explanatory variables are fixed at the same time lag and same time window, for reasons such as the variables becoming too many or the calculation becoming unstable, and there is expected the obtaining of a model with higher precision near that of a true model. In addition, there is enabled further mitigation by regularization of instability of the model calculation that remains by multicollinearity only by the cumulative series conversion. Moreover, by adjusting the effective condition of regularization with a regularization parameter, the weight of variables unneeded for prediction is suppressed and the proportion of nonzero elements in the weights of the cumulative series variables is adjusted, and this enables changing the complexity of the model to be expressed.

To this point, the situation of selecting a single lag and window width by the sliding window method has been considered, but, with more complex fluctuations of temporal impact, expression is possible by adjusting the regularization parameter (S22) in order to produce three or more count for the quantity of nonzero weights for the cumulative series variables for (S23). For example, the weight of c_t̂5 (gap g=5) becomes 2.0, the weight of c_t̂10 (gap g=10) becomes −1.0, the weight of c_t̂15 (gap g=15) becomes −1.0, resulting in N+M=20. By weighting and summing these cumulative series, there is obtained the following value c′_t.

c′_{—}t=2*{x_(t−5)+ . . . x_(t−20)}

−{x_(t−10)+ . . . +x_(t−20)}

−{x_(t−15)+ . . . +x_(t−20)}

={x_(t−5)+ . . . +x_(t−9)}{x_(t−5)+ . . . +x_(t−14)}

=2*{x_(t−5)+ . . . x_(t−9)}+{x_(t−10)+ . . . +x_(t−14)}

This is equivalent to when lag L=5 and a window width W=10, and this enables interpreting that double the weights are attached for the window forward half in comparison to the window latter half.

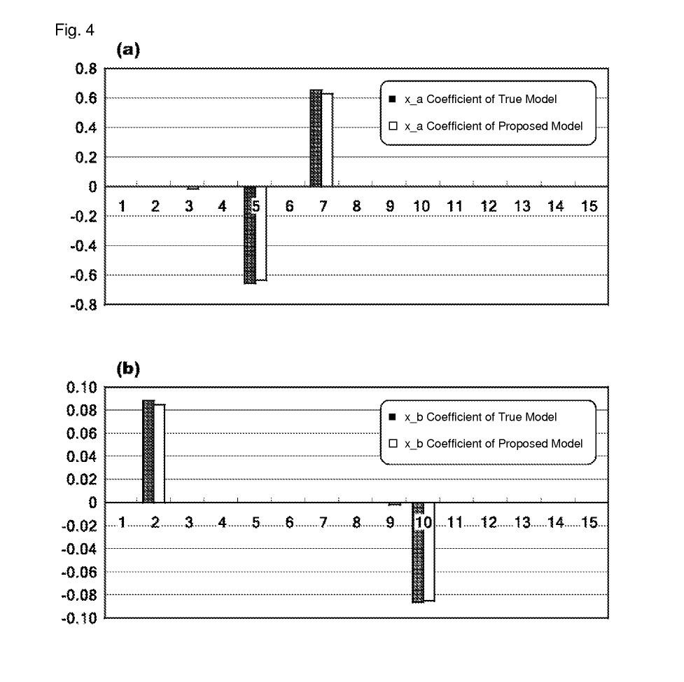

The following section describes an example of an experiment that verifies the effect of this implementation mode, as illustrated in FIG. 4-7.

Experiment Settings: The settings for the experiment were as follows.

### 1. Original Explanatory Variables Time Series: Variables

x_{—}a=sin(2x)+e

x_{—}b=cos(x)+e

Wherein, (e˜N(0, 0.5̂2))

### 2. Target Variable Time Series: True Model Calculation

True Recovery Model: y=1.3*sw(x_{—}a, 5, 2)−0.7*sw(x_{—}b, 2, 8)+e

Function sw(x, 1, w): shift average for sliding window of Lag 1, Window w

### 3. Candidates for Time Lag and Window Width

Lag 1={0, 1, 2, 3, 4, 5}

Window Width w={0, 1, 2, 3, 4, 5, 6, 7, 8, 9, 10}

### 4. Method

Existing Method:

Calculates conversion series for a combination of all candidate lag and window width

Applies LARS (least angle regression) for L1 regularized linear recovery

Proposal Method (Implementation Mode):

Calculates cumulative conversion series for maximum candidate lag plus maximum window width

Applies LARS (least angle regression) for L1 regularized linear recovery

Model Selection: Regularization parameter selects CP statistic minimum

Training Data: 50,000 samples

### 5. Evaluation Method

Compared coefficient weights of the true model and presumed model

Compared the prediction accuracy for the test data and the reduction effect for calculation time

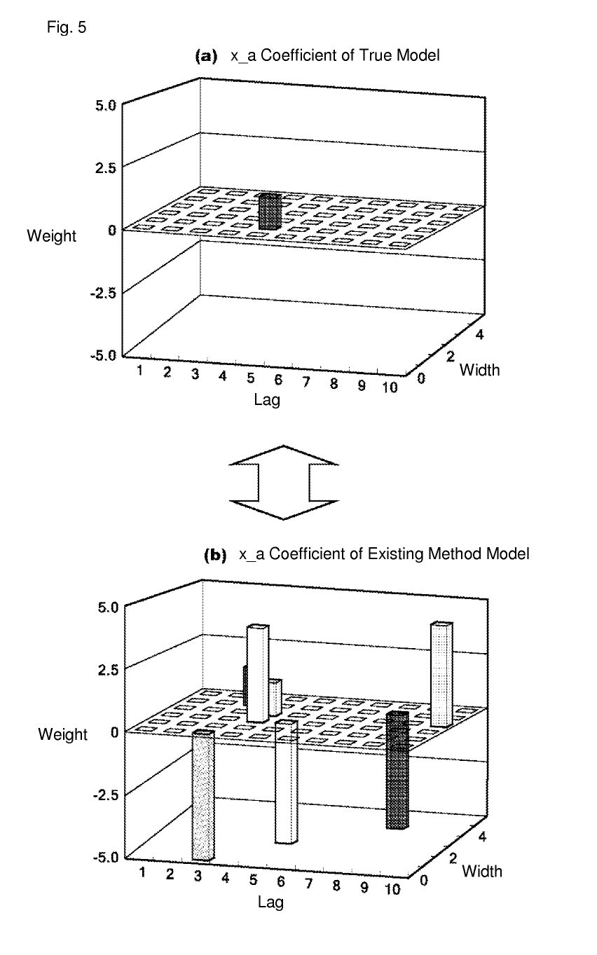

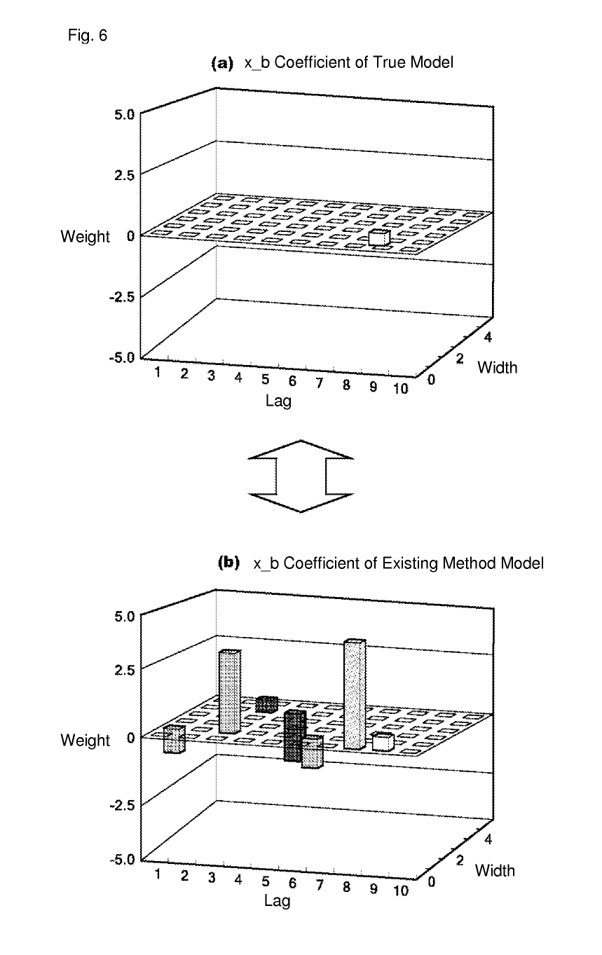

FIG. 4 is a chart that compares the x_a coefficient and x_b coefficient of a true model with the x_a coefficient and x_b coefficient of the proposed method model. For both the x_a coefficient (FIG. 4 (a)) and x_b coefficient (FIG. 4 (b)) the proposed method model is near the true model, and it is understood that there is space. FIG. 5 is a chart that compares the x_a coefficient of the proposed model (FIG. 5 (a)) with the x_a coefficient of an existing model (FIG. 5 (b)). In addition, FIG. 6 is a chart that compares the x_b coefficient of the proposed model (FIG. 6 (a)) with the x_b coefficient of an existing model (FIG. 6 (b)). With any of the coefficients of the proposed model there is space, but, in comparison to this, with any of the coefficients of the existing model there is generated excess learning by multicollinearity, and therefore it is understood that large weights are unnecessarily applied to many of the coefficients.

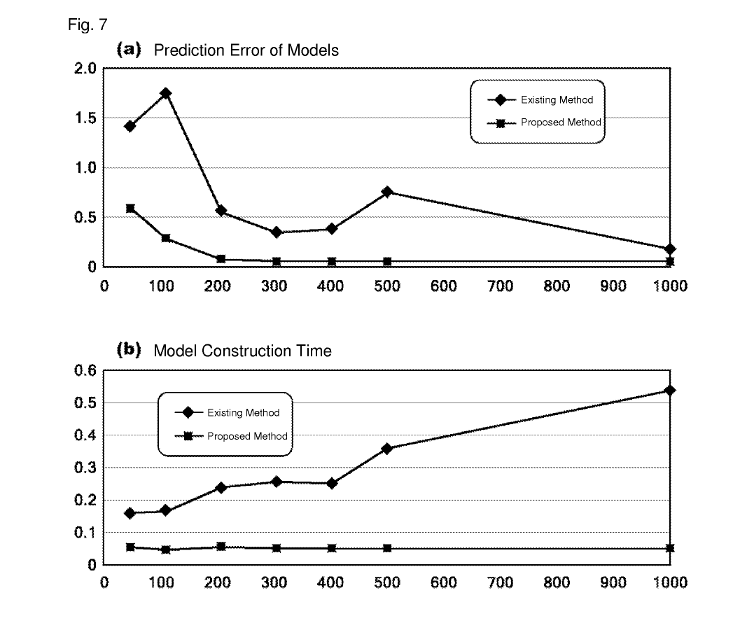

FIG. 7 is a chart that shows prediction error (FIG. 7 (a)) and the model construction time (FIG. 7 (b)), when the training data quantity is made {50, 100, 200, 300, 400, 500, 1000} and the test data quantity made 100 (a true model with no noise: y=1.3*sw(x_a, 5, 2)−0.7*sw(x_b, 2, 8)). It is understood that the proposed method is superior from the viewpoint of prediction error and from the viewpoint of model construction time in comparison to the existing method.

While the disclosure has been described with reference to an exemplary embodiment or embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1-8. (canceled)

9. A computer program product comprising a computer readable storage medium having computer readable code stored thereon that, when executed by a computer, implement a method, comprising:
selecting with the computer, a time lag that is the time delay until an explanatory variable time sequence applies an effect on a target variable time series, and a time window that is the time period for the explanatory variable time series to apply the impact on the target variable time series;
converting, based upon the explanatory variable time series, to a cumulative time series structured by the cumulative values of each variable from each time point corresponding to a certain finite time; and
solving the cumulative time series as an optimized problem introducing a regularization term, to obtain the value of the time lag and the value of the time window from the solved weight.

10. The computer program product according to claim 9, wherein the finite time is memory set to the computer in advance.

11. The computer program product according to claim 9, wherein the finite time is inputted to the computer by a user.

12. The computer program product according to claim 9, wherein the regularization term is an L1 regularization term.

13. The computer program product according to claim 9, wherein the solving comprises adjusting the regularization parameter.

14. The computer program product according to 13, wherein the adjusting is continued until only the weights for several count of cumulative sequence explanatory variables for the original explanatory variables required for prediction become nonzero.

15. The computer program product according to 13, wherein the adjusting is continued until only the weights for two counts of cumulative sequence explanatory variables for the original explanatory variables required for prediction become nonzero.

16. The computer program product according to claim 15, wherein the size of the two counts of cumulative series explanatory variables are equal in number and have a polar inverse relationship.

17. A system, comprising:
a computer configured to select a time lag that is the time delay until an explanatory variable time sequence applies an effect on a target variable time series, and a time window that is the time period for the explanatory variable time series to apply the impact on the target variable time series;
the computer configured to convert, based upon the explanatory variable time series, to a cumulative time series structured by the cumulative values of each variable from each time point corresponding to a certain finite time; and
solve the cumulative time series as an optimized problem introducing a regularization term, to obtain the value of the time lag and the value of the time window from the solved weight.

18. The system according to claim 17, wherein the finite time is memory set to the computer in advance.

19. The system according to claim 17, wherein the finite time is inputted to the computer by a user.

20. The system according to claim 17, wherein the regularization term is an L1 regularization term.

21. The system according to claim 17, wherein the solving comprises adjusting the regularization parameter.

22. The system according to 21, wherein the adjusting is continued until only the weights for several count of cumulative sequence explanatory variables for the original explanatory variables required for prediction become nonzero.

23. The system according to 21, wherein the adjusting is continued until only the weights for two counts of cumulative sequence explanatory variables for the original explanatory variables required for prediction become nonzero.

24. The system according to claim 23, wherein the size of the two counts of cumulative series explanatory variables are equal in number and have a polar inverse relationship.
